(19) United States
(12) Patent Application Publication
(10) Pub. No.: US 2010/0306996 A1
(43) Pub. Date: Dec. 9, 2010

(54) PIERCE NUT INSTALLATION TOOL

(75) Inventors: William D. Lamb, Saline, MI (US); Dale Irving, Wilsonville, OR (US)

Correspondence Address: DOBRUSIN & THENNISCH PC, 29 W LAWRENCE ST, SUITE 210, PONTIAC, MI, 48342, US

(73) Assignee: Fastener Advance Products

(21) Appl. No.: 12/478,287

(22) Filed: Jun. 4, 2009

(51) Int. Cl. B23P 19/06

(52) U.S. Cl. 29/798

(57) ABSTRACT

The present invention is premised upon an improved pierce nut installation device for use between a top and a bottom plate of a press or die tool. The device is used for installing pierce nuts onto a panel for receiving the pierce nuts (with or without a pre-punched hole). The device at least includes an installation punch with a top punch portion and a bottom punch portion, wherein the top punch portion is connected to the top plate of the press or die tool and a base assembly with a top base portion and a bottom base portion.

### FIELD OF THE INVENTION

The present invention relates to an improved pierce nut installation tool, more particularly an installation tool for installing a pierce nut into a panel.

### BACKGROUND

Generally, pierce nuts have been used in industry for many decades. There continue to be efforts to develop and improve the devices used to install piece nuts into panels. The present invention is the culmination of one such effort. It is believed that the installation tools currently in use in industry have proven to be less reliable than desired, contain too many moving parts and may be difficult to maintain. Additionally, it is believed that the current art may fail to provide adequate feedback or communication to and/or from the device and any press or tool in which the device may be located.

Among the literature that may pertain to this technology include the following patent documents: U.S. Pat. No. 6,578,258; U.S. Pat. No. 6,631,827; U.S. Pat. No. 6,912,776; U.S. Pat. No. 6,925,698; U.S. Pat. No. 6,957,483; and U.S. Pat. No. 6,993,831, all incorporated herein by reference for all purposes.

### SUMMARY OF THE INVENTION

The present invention is directed to one such solution, and particularly is directed to an improved installation tool that may provide a more reliable and cost effective means of installing pierce nuts into various panels.

Accordingly, pursuant to a first aspect of the present invention, there is contemplated a pierce nut installation device for use between a top and a bottom plate of a press or die tool for installing pierce nuts onto a panel for receiving the pierce nuts, at least including: an installation punch with a top punch portion and a bottom punch portion, wherein the top punch portion is connected to the top plate of the press or die tool; and a base assembly with a top base portion and a bottom base portion, the top base portion including a pierce nut track, at least one nut actuation device, a push rod connected to the at least one nut actuation device and disposed above the pierce nut track, a retention rod disposed above the pierce nut track, an installation head including a punch channel, and a punch sensor that detects the presence of the bottom punch portion and is disposed adjacent to the punch channel; and the bottom base portion including at least one return actuation device and a lower die button, both disposed in a base plate, wherein the bottom base portion is at least partially disposed on the bottom plate of the press or die tool and the top base portion is rotatably connected at one end via a pivot.

The first aspect of the present invention may be further characterized by one or any combination of the features described herein, such as the at least one nut actuation device comprises a pneumatic cylinder; the at least one return actuation device comprises a pneumatic cylinder; the push rod is rotatably connected to the top base portion and includes a push rod spring for biasing an angled rod shaft into a hole in the pierce nuts; the retention rod is rotatably connected to the top base portion and includes a retention spring for biasing an angled retention shaft into a hole in the pierce nuts; including a control device in communication with at least one of the punch sensor, the nut actuation device, or the return actuation device; including a control table, wherein the bottom base portion is at least partially disposed on the control table; the control table includes the control device disposed thereon; the control table includes a pierce nut spool disposed thereon; the at least one nut actuation device, the at least one return actuation device, and the punch sensor communicate with the control device; the installation head includes at least two opposing rotatably adjustable locator arms adapted to nest with opposing side walls of a piece nut.

Accordingly, pursuant to a second aspect of the present invention, there is contemplated a pierce nut installation device for use between a top and a bottom plate of a press or die tool for installing pierce nuts onto a panel for receiving the pierce nuts, at least including: an installation punch with a top punch portion and a bottom punch portion, wherein the top punch portion is connected to the top plate of the press or die tool; and a base assembly with a top base portion and a bottom base portion, the top base portion including a pierce nut track, at least one nut actuation device, a push rod connected to the at least one nut actuation device and disposed above the pierce nut track, a retention rod disposed above the pierce nut track, an installation head including a punch channel, at least two opposing rotatably adjustable locator arms, and a punch sensor that detects the presence of the bottom punch portion and is disposed adjacent to the punch channel; and the bottom base portion including a lower die button, both disposed in a base plate; wherein the bottom base portion is at least partially disposed on the bottom plate of the press or die tool and the top base portion is at least partially disposed on a stripper plate.

The second aspect of the present invention may be further characterized by one or any combination of the features described herein, such as the at least one nut actuation device comprises a pneumatic cylinder; the at least one return actuation device comprises a pneumatic cylinder; the push rod is rotatably connected to the top base portion and includes a push rod spring for biasing an angled rod shaft into a hole in the pierce nuts; the retention rod is rotatably connected to the top base portion and includes a retention spring for biasing an angled retention shaft into a hole in the pierce nuts; including a control device in communication with at least one of the punch sensor or the nut actuation device; including a control table, wherein the bottom base portion is at least partially disposed on the control table; the control table includes a pierce nut spool disposed thereon; the at least one nut actuation device, the at least one return actuation device, and the punch sensor communicate with the control device.

### DESCRIPTION OF THE DRAWINGS

FIG. 1 is a perspective view of the improved pierce nut installation tool according to the present invention.

FIG. 2 is a perspective view of the nut and a pre-punched panel.

FIG. 3 is a sectional view through the center of the tool of FIG. 1.

FIG. 4 is a rear perspective view of a portion of the tool of FIG. 1.

FIG. 5 is a side view of the tool installed in a press.

FIG. 6 is a side view of a portion of the tool of FIG. 1.

FIG. 7 is a sectional front view through the head section according to the present invention.

FIG. 8 is a perspective view of an improved pierce nut installation tool station according to the present invention.

### DETAILED DESCRIPTION OF THE PREFERRED EMBODIMENT

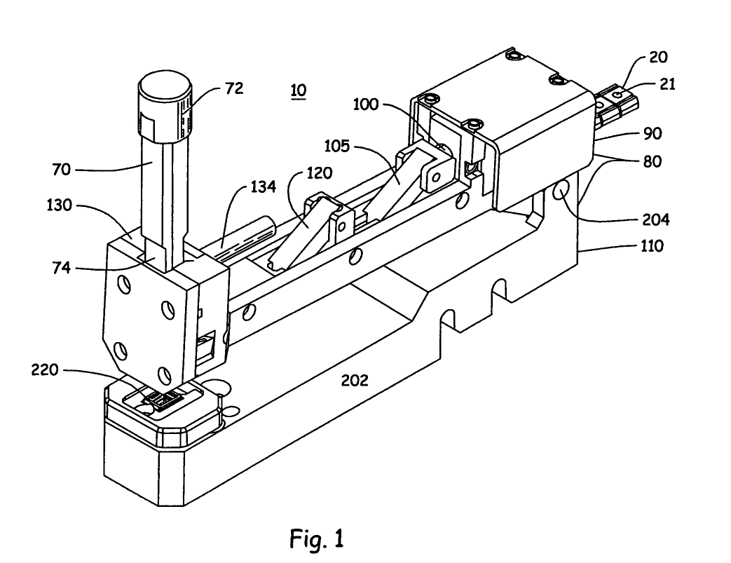

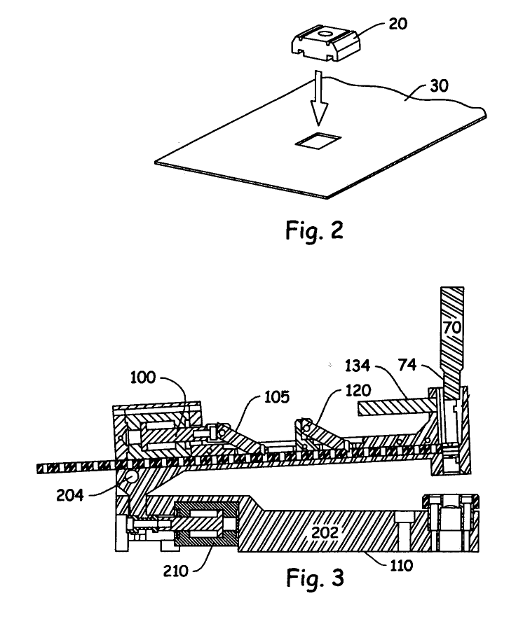

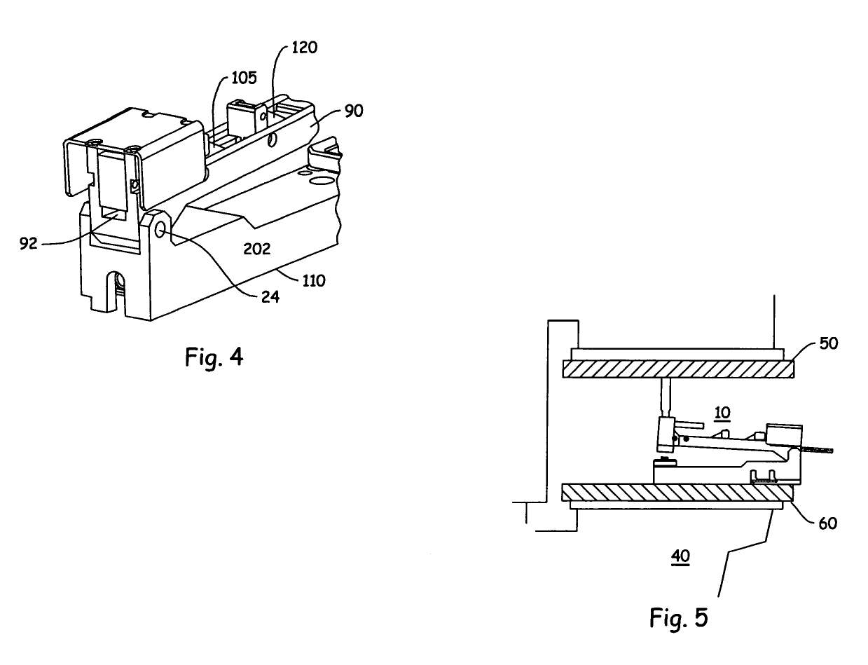

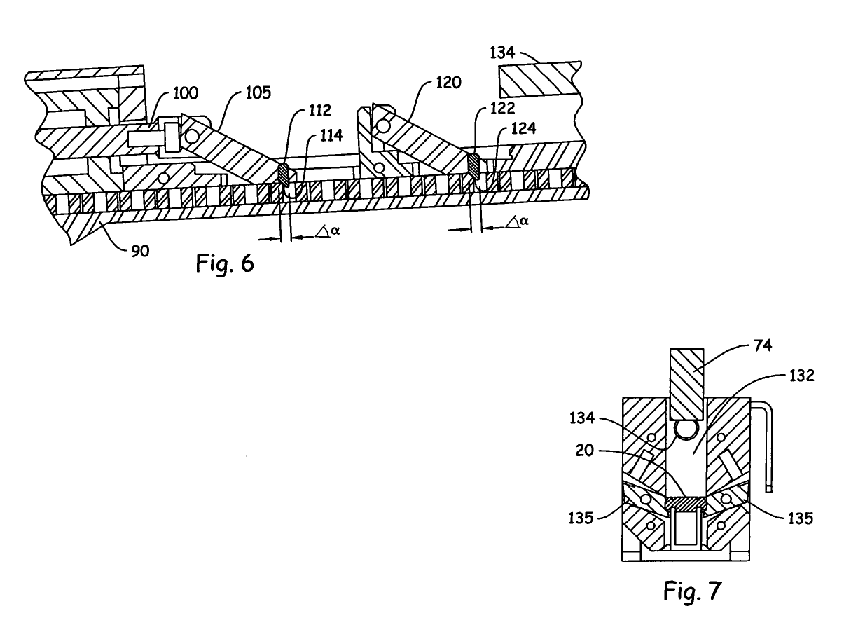

The invention is an improved pierce nut installation tool 10, as illustrated in FIGS. 1, 3-8. It is contemplated that the pierce nut tool may be used to install pierce nuts, for example nuts 20, preferably into pre-punched hole in panels 30 (e.g. sheet metal panels), for example as seen in FIG. 2. It is also contemplated that the panel 30 may be free of any holes and the nut 20 is such that it pierces the hole during the installation process. It is well known that the nuts 20 in this type of application are typically supplied on rolls and are interconnected via frangible wire in a series. It is contemplated that the installation tool 10 may be at least partially located in a press 40 or die tool (e.g. between the top and bottom plates 50, 60 of the press or die tool), wherein the press 40 providing the force necessary to deform a portion of nut 20 (and possibly piercing the hole), thus securing it to the panel 30.

It is contemplated that the installation tool 10 may include an installation punch 70 with a top punch portion 72 and a bottom punch portion 74, wherein the top punch portion 72 may be connected to the top plate 50 of the press or die tool.

It is contemplated that the installation tool 10 also may include a base assembly 80 with a top base portion 90 and a bottom base portion 110, each described in greater detail below.

As a general statement, most if not all of the components of the tool 10 may be constructed of a robust material that allows long ware and tool life. For example, materials such as mild steel, tool steel, aluminum, magnesium, or the like.

### Top Base Portion

It is contemplated that the top base portion 90 may include a number or components and/or features, all interconnected to form an assembly. The top base portion 90 may include a pierce nut track 92. This track may be defined as a channel in the top base portion 90, at least one nut actuation device 100, a nut push rod 105 rotationally connected to the at least one nut actuation device 100 and disposed above the pierce nut track 92. Also, a nut retention rod 120 disposed above the pierce nut track 92 and rotationally connected to the top base portion 90, an installation head section 130 including a punch channel 132, a punch sensor 134 that detects the presence of the bottom punch portion 74 and is disposed adjacent to the punch channel 132.

It is contemplated that the pierce nut track 92 may comprise a channel located in the top base portion 90. The channel may have a profile that closely matches the profile of the nuts 20 that travel within the channel. The track 92 is preferably has a profile geometry that is about 2% or more large than that of the nut 20 and has a smooth surface to allow the movement of the nut 20 through the track 92. It is also contemplated that the track 92 is open at the top at least in the area of the center hole 22 in the nut 20 so that the nut push rod 105 and the nut retention rod 120 can at least partially engage the hole of the nut 20 (holding the nut 20 from moving rearward in the track 92.

The at least one nut actuation device 100 functions to at least provide the linear forward and rearward movement to the nut push rod 105 (which in turn indexes the nuts 20 forward in the tool 10.). In a preferred embodiment, this device 100 is a pneumatic cylinder and may be disposed above the nut track 92. It is also contemplated that it may also be a hydraulic cylinder or the like. The device 100 also may be in communication with a control device 260 discussed in further detail later in this application.

The nut retention rod 120 and/or the nut push rod 105 may include a head portion 122, 112, that is adapted to fit at least partially within the center hole 21 of the nut 20 and has an angled back wall 124, 114. The angled back wall 124, 114 serves to allow the rods 105, 120 to rotate out of the hole 21. In the case of the retention rod 120, when the nuts 20 move forward in the pierce nut track 92. In the case of the push rod 105, when the nut actuation device 100 is retracted. The angled back wall preferably has an angle α of between about 25° and 60°, more preferably between about 35° and 50°. The rods 105, 120 may also include a biasing spring (not shown) that biases the rotation of the rods 105, 120 towards the nuts 20 in the track 92.

The installation head section 130 may be disposed at or near one end of the top base portion 90. The head section 130 is where the nut track 92 ends and where the action of separating the nut 20 from the frangible wire and in conjunction with the bottom bas portion 110, secures the nut 20 to the panel 30. The head section 130 may include a punch channel 132 and a punch sensor 134.

The punch sensor 134 functions to detect the presence (e.g. proximity sensor) of the bottom punch portion 74, whereby it preferably communicates with the at least one return actuation device 210 (described further in the “BOTTOM BASE PORTION” below). The sensor 134 may be disposed adjacent to the punch channel 132.

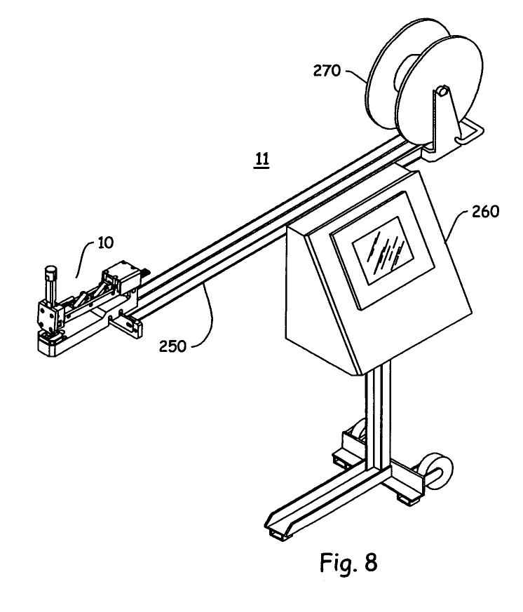

As shown in FIG. 7, it is contemplated that the installation head section 130 may also include at least two opposing rotatably adjustable locator arms 135 adapted to nest with opposing side walls of the pierce nut 20. The locator arms may be spring loaded to bias the rotation towards the nut 20.

### Bottom Base Portion

It is contemplated that the bottom base portion 110 may include a number or components and/or features, all interconnected to form an assembly. The bottom base portion 110 may include at least one return actuation device 210 and a lower die button 220, both disposed in a base plate 202. It is contemplated that when installed, the bottom base portion 110 is at least partially disposed on the bottom plate 60 of the press or die tool. It is also contemplated that at least in one embodiment, that the bottom base portion 110 and the top base portion 90 are rotatably connected at or near one end via a pivot 204. The lower die button 220 functions to aid in the bending of the nut 20 during installation in the panel 30, as is customary in the art.

In a preferred embodiment, one which includes the at least one return actuation device 210, a movable portion of the device 210 is connected to the top base portion and functions to open and close the top and bottom portions 110, 90 by forcing the rotation about the pivot 204. In the most preferred embodiment, the device 210 is activated by the presence or lack thereof of the bottom punch portion 74 as communicated by the punch sensor 134 (either directly or indirectly). In a preferred embodiment, the device 210 is a pneumatic cylinder, although it is contemplated that it may also be a hydraulic cylinder or the like.

In another embodiment, the at least one return actuation device 210 is not present, and the top and bottom portions 90, 110 are not connected via a pivot. In this embodiment, the top portion 90 may be at least partially disposed on a stripper plate (not shown) connected to the press or die tool. This typically would be the case if the panel 30 would not fit between the top and bottom portions 90, 110.

### Improved Pierce Nut Installation Tool Station

As a further aspect of the present invention, it is contemplated that the improved pierce nut installation tool 10 may include all of or a combination of a control table 250, a control device 260, and a piece nut spool 270, to form an improved pierce nut installation tool station 11, see FIG. 8. It may be preferred that when the control table 250 is present, the bottom base portion 110 is at least partially disposed on the control table 250 or connected thereto in some manner.

The control table 250, simple functions a platform for the station 11 components listed above. It may be placed on wheels to make it easier to move from press to press. The control table 250 may also contain additional sensors, such as nut detecting sensors (not shown) that function to detect the presence of nuts 20 (e.g. that the spool 270 has not run out of its supply of nuts).

It is contemplated that the control device 260 may be a programmable digital device (e.g. computer, Plc, or other control device) that communicates with the devices in the tool 10. It may also communicate with the press 40 or any control system of the press 40. Some of the devices in the tool 10 that the control device 260 may communicate with and control include the punch sensor 134 and the actuation devices 100, 210. Preferably, for example, the control device 260 receives a signal from the punch sensor 134 (detecting the presence of the bottom punch portion 74) and then causes the at least one return actuation device 210 to activate, rotating the top base portion 90 to a closed position, and putting the tool 10 in a arrangement where the nut 20 is installed to the panel. In another example, the control device causes the at least one nut actuation device 100 to move forward to index the nuts 20 into installation position.

Unless stated otherwise, dimensions and geometries of the various structures depicted herein are not intended to be restrictive of the invention, and other dimensions or geometries are possible. Plural structural components can be provided by a single integrated structure. Alternatively, a single integrated structure might be divided into separate plural components. In addition, while a feature of the present invention may have been described in the context of only one of the illustrated embodiments, such feature may be combined with one or more other features of other embodiments, for any given application. It will also be appreciated from the above that the fabrication of the unique structures herein and the operation thereof also constitute methods in accordance with the present invention.

The preferred embodiment of the present invention has been disclosed. A person of ordinary skill in the art would realize however, that certain modifications would come within the teachings of this invention. Therefore, the following claims should be studied to determine the true scope and content of the invention.

Any numerical values recited in the above application include all values from the lower value to the upper value in increments of one unit provided that there is a separation of at least 2 units between any lower value and any higher value. As an example, if it is stated that the amount of a component or a value of a process variable such as, for example, temperature, pressure, time and the like is, for example, from 1 to 90, preferably from 20 to 80, more preferably from 30 to 70, it is intended that values such as 15 to 85, 22 to 68, 43 to 51, 30 to 32 etc. are expressly enumerated in this specification. For values which are less than one, one unit is considered to be 0.0001, 0.001, 0.01 or 0.1 as appropriate. These are only examples of what is specifically intended and all possible combinations of numerical values between the lowest value and the highest value enumerated are to be considered to be expressly stated in this application in a similar manner.

Unless otherwise stated, all ranges include both endpoints and all numbers between the endpoints. The use of “about” or “approximately” in connection with a range applies to both ends of the range. Thus, “about 20 to 30” is intended to cover “about 20 to about 30”, inclusive of at least the specified endpoints.

The disclosures of all articles and references, including patent applications and publications, are incorporated by reference for all purposes.

The term “consisting essentially of” to describe a combination shall include the elements, ingredients, components or steps identified, and such other elements ingredients, components or steps that do not materially affect the basic and novel characteristics of the combination.

The use of the terms “comprising” or “including” to describe combinations of elements, ingredients, components or steps herein also contemplates embodiments that consist essentially of the elements, ingredients, components or steps.

Plural elements, ingredients, components or steps can be provided by a single integrated element, ingredient, component or step. Alternatively, a single integrated element, ingredient, component or step might be divided into separate plural elements, ingredients, components or steps. The disclosure of “a” or “one” to describe an element, ingredient, component or step is not intended to foreclose additional elements, ingredients, components or steps. All references herein to elements or metals belonging to a certain Group refer to the Periodic Table of the Elements published and copyrighted by CRC Press, Inc., 1989. Any reference to the Group or Groups shall be to the Group or Groups as reflected in this Periodic Table of the Elements using the IUPAC system for numbering groups.

What is claimed is:

1. A pierce nut installation device for use between a top and a bottom plate of a press or die tool for installing pierce nuts onto a panel for receiving the pierce nuts, comprising:
an installation punch with a top punch portion and a bottom punch portion, wherein the top punch portion is connected to the top plate of the press or die tool; and
a base assembly with a top base portion and a bottom base portion,
the top base portion including a pierce nut track, at least one nut actuation device, a push rod connected to the at least one nut actuation device and disposed above the pierce nut track, a retention rod disposed above the pierce nut track, an installation head including a punch channel, and a punch sensor that detects the presence of the bottom punch portion and is disposed adjacent to the punch channel; and
the bottom base portion including at least one return actuation device and a lower die button, both disposed in a base plate, wherein the bottom base portion is at least partially disposed on the bottom plate of the press or die tool and the top base portion is rotatably connected at one end via a pivot.

2. The pierce nut installation device according to claim 1, wherein the at least one nut actuation device comprises a pneumatic cylinder.

3. The pierce nut installation device according to claim 1, wherein the at least one return actuation device comprises a pneumatic cylinder.

4. The pierce nut installation device according to claim 1, wherein the push rod is rotatably connected to the top base portion and includes a push rod spring for biasing an angled rod shaft into a hole in the pierce nuts.

5. The pierce nut installation device according to claim 1, wherein the retention rod is rotatably connected to the top base portion and includes a retention spring for biasing an angled retention shaft into a hole in the pierce nuts.

6. The pierce nut installation device according to claim 1, further including a control device in communication with at least one of the punch sensor, the nut actuation device, or the return actuation device.

7. The pierce nut installation device according to claim 1, further including a control table, wherein the bottom base portion is at least partially disposed on the control table.

8. The pierce nut installation device according to claim 7, wherein the control table includes the control device disposed thereon.

9. The pierce nut installation device according to claim 7, wherein the control table includes a pierce nut spool disposed thereon.

10. The pierce nut installation device according to claim 6, wherein the at least one nut actuation device, the at least one return actuation device, and the punch sensor communicate with the control device.

11. The pierce nut installation device according to claim 1, wherein the installation head includes at least two opposing rotatably adjustable locator arms adapted to nest with opposing side walls of a piece nut.

12. A pierce nut installation device for use between a top and a bottom plate of a press or die tool for installing pierce nuts onto a panel for receiving the pierce nuts, comprising:
an installation punch with a top punch portion and a bottom punch portion, wherein the top punch portion is connected to the top plate of the press or die tool; and
a base assembly with a top base portion and a bottom base portion,
the top base portion including a pierce nut track, at least one nut actuation device, a push rod connected to the at least one nut actuation device and disposed above the pierce nut track, a retention rod disposed above the pierce nut track, an installation head including a punch channel, at least two opposing rotatably adjustable locator arms, and a punch sensor that detects the presence of the bottom punch portion and is disposed adjacent to the punch channel; and
the bottom base portion including a lower die button, both disposed in a base plate;
wherein the bottom base portion is at least partially disposed on the bottom plate of the press or die tool and the top base portion is at least partially disposed on a stripper plate.

13. The pierce nut installation device according to claim 12, wherein the at least one nut actuation device comprises a pneumatic cylinder.

14. The pierce nut installation device according to claim 12, wherein the push rod is rotatably connected to the top base portion and includes a push rod spring for biasing an angled rod shaft into a hole in the pierce nuts.

15. The pierce nut installation device according to claim 12, wherein the retention rod is rotatably connected to the top base portion and includes a retention spring for biasing an angled retention shaft into a hole in the pierce nuts.

16. The pierce nut installation device according to claim 12, further including a control device in communication with at least one of the punch sensor or the return actuation device.

17. The pierce nut installation device according to claim 12, further including a control table, wherein the bottom base portion is at least partially disposed on the control table.

18. The pierce nut installation device according to claim 17, wherein the control table includes a pierce nut spool disposed thereon.

19. The pierce nut installation device according to claim 18, wherein the at least one nut actuation device, the at least one return actuation device, and the punch sensor communicate with the control device.
